(19) United States
(12) Patent Application Publication
(10) Pub. No.: US 2021/0326555 A1
(43) Pub. Date: Oct. 21, 2021

(54) DISPLAY PANEL AND DISPLAY DEVICE

(71) Applicant: WUHAN CHINA STAR OPTOELECTRONICS TECHNOLOGY CO., LTD., Wuhan, Hubei (CN)

(72) Inventor: Li HU, Wuhan, Hubei (CN)

(21) Appl. No.: 16/492,251

(22) PCT Filed: Aug. 14, 2019
(86) PCT No.: PCT/CN2019/100598

§ 371 Date: Sep. 9, 2019

(30) Foreign Application Priority Data
Apr. 30, 2019 (CN) 201910358659.7

(51) Int. Cl. G06K 9/00; G02F 1/1333

(52) U.S. Cl. CPC G06K 9/0004; G02F 1/133512; G02F 1/13338

(57) ABSTRACT

A display panel and a display device are provided. The display panel includes a first substrate, a second substrate, and a liquid crystal layer disposed between the first substrate and second substrate. The second substrate includes a pixel layer with a plurality of pixel units. At least one fingerprint identification unit is disposed in the second substrate and located in a gap between the pixel units. The fingerprint identification units are formed on a color filter substrate of the display panel to integrate a display function, a touch control function, and a fingerprint identification function, thereby reducing cost and thickness of a module. Furthermore, by disposing a light converging layer, light is avoided from being interfered, and interference between the adjacent pixel units can be reduced. Further, a planar light source is used for increasing uniformity of light, thereby increasing image quality of the fingerprint identification units.

### FIELD OF INVENTION

The present invention relates to a field of display and, more particularly, to a display panel and a display device.

### BACKGROUND OF INVENTION

In current display devices such as intelligent mobile phones, a fingerprint identification sensor is usually disposed on a home key. With emergence of full-screen displays, a frame of a display screen is becoming narrower and narrower, and the home key of a display is removed. Technology of disposing the fingerprint identification sensor on a backside or on a side of the mobile phone is to be abandoned. On the contrary, technology of disposing the fingerprint identification sensor inside the display screen is becoming a major trend of development of fingerprint identification technology.

Nowadays, in conventional in-display fingerprint identification sensors, material of a substrate is silicon. However, the conventional in-display fingerprint identifications have disadvantages such as high cost and difficult manufacturing process. Moreover, the conventional in-display fingerprint identification sensor is separated from the display screen and occupies a certain space.

Backlight system of edge-lighting light emitting diodes (LEDs) are used on current liquid crystal display panels. However, a light source provided from the backlight system is non-uniform, and the utilization of the light source is low. Therefore, the fingerprint image closed to the LED is brighter than the fingerprint image away from the LED, thereby badly affecting image quality of optical fingerprint identification sensors.

Therefore, it is necessary to provide a new technical method to solve the above problems.

### SUMMARY OF INVENTION

A purpose of the present invention is providing a display panel and a display device. In the present invention, fingerprint identification units are formed on a color filter substrate of the display panel to integrate functions of display, touch control, and fingerprint identification, thereby reducing cost and thickness of a module. Further, a planar light source is applied to the display panel to increase uniformity of backlight, which solves the problem about nonuniformity of backlight of fingerprint identification units, thereby improving image quality of the fingerprint identification units. As a result, uniformity of grayscale of the whole fingerprint image is improved, utilization of a light source is increased, and energy consumption is decreased.

To achieve the above goals, the present invention provides a display panel including a first substrate, a second substrate, and a liquid crystal layer disposed between the first substrate and the second substrate. Specifically, the second substrate is disposed opposite to the first substrate, and the second substrate is disposed on the first substrate. The liquid crystal layer is disposed between the first substrate and the second substrate.

The second substrate includes a pixel layer including a plurality of pixel units, and at least one fingerprint identification unit is disposed in the second substrate and located in a gap between the pixel units.

Further, the pixel layer includes a black matrix layer and the pixel units disposed in a plurality of grids of the black matrix layer and through the black matrix layer. The fingerprint identification units are disposed on a side of the black matrix layer.

Further, each of the pixel units includes three subpixels disposed abreast side by side. A length of the fingerprint identification unit is an integer multiple of a width of the three subpixels disposed abreast.

Further, the fingerprint identification unit includes a first electrode layer, a hole transport layer, a photosensitive layer, an electron transport layer, a second electrode layer, and a second thin film transistor array substrate stacked sequentially. Specifically, the first electrode layer is disposed on the black matrix layer; the hole transport layer is disposed on the first electrode layer; the photosensitive layer is disposed on the hole transport layer; the electron transport layer is disposed on the photosensitive layer; the second electrode layer is disposed on the electron transport layer; and the second thin film transistor array substrate is disposed on the second electrode layer and is connected to a color filter substrate.

Further, the second substrate further includes a color filter substrate disposed on the fingerprint identification units, and a light converging layer disposed on a side of the color filter substrate away from the fingerprint identification units. The light converging layer includes an adhesive layer. At least a convex lens unit is disposed on the adhesive layer, and the convex lens units and the fingerprint identification units are corresponding one by one in arrangement.

Further, the light converging layer further includes a filled layer, the filled layer is disposed on a side of the adhesive layer away from the color filter substrate.

Further, the second substrate further includes a polarizer, an optically clear adhesive layer, and a protective layer. Specifically, the polarizer is disposed on a side of the light converging layer away from the color filter substrate; the optically clear adhesive layer is disposed on the polarizer; the protective layer is disposed on the optically clear adhesive layer.

Further, the first substrate includes a first thin film transistor array substrate and an alignment film. The alignment film is disposed on the first thin film transistor array substrate and is connected to the liquid crystal layer.

Further, the display panel further includes a planar light source disposed on a side of the first substrate away from the liquid crystal layer. The planar light source includes a reflective sheet, a light emitting diode, a diffuser, a brightness enhancement film, and a reflective brightness enhancement film stacked sequentially. Specifically, the light emitting diode is disposed on the reflective sheet; the diffuser is disposed on the light emitting diode; the brightness enhancement film is disposed on the diffuser; the reflective brightness enhancement film is disposed on the brightness enhancement film and is connected to the first substrate.

The present invention further provides a display device including the above display panel.

The advantageous effects of the present invention: a display panel and a display device are provided. Fingerprint identification units are formed on a color filter substrate of the display panel to integrate functions of display, touch control, and fingerprint identification, thereby reducing cost and thickness of a module. Furthermore, by disposing a light converging layer, light distributed in a larger angle range is incident to the fingerprint identification units in a smaller angle range, which avoids the light from being interfered and reduces the interference between the adjacent pixel units. Further, a planar light source is applied to the display panel to increase uniformity of backlight, which solves the problem about nonuniformity of backlight of fingerprint identification units, thereby improving image quality of the fingerprint identification units. As a result, uniformity of grayscale of the whole fingerprint image is improved, utilization of a light source is increased, and energy consumption is decreased.

### DESCRIPTION OF DRAWINGS

FIG. 1 is a schematic structural diagram of a display panel according to an embodiment of the present invention.

FIG. 2 is a schematic plan view of a structure of a display panel according to an embodiment of the present invention.

FIG. 3 is a schematic plan view of a structure of a display panel according to another embodiment of the present invention.

FIG. 4 is a schematic structure plan view of a fingerprint identification unit according to an embodiment of the present invention.

FIG. 5 is a schematic structural diagram of a planar light source according to an embodiment of the present invention.

Components are identified as follows: a first substrate 10; a second substrate 20; a liquid crystal layer 30; a planar light source 40; a first thin film transistor array substrate 11; an alignment film 12; a pixel layer 21; a fingerprint identification unit 22; a color filter substrate 23; a light converging layer 24; a polarizer 25; an optically clear adhesive layer 26; a protective layer 27; a sealant layer 31; a reflective sheet 41; a light emitting diode 42; a diffuser 43; a brightness enhancement film 44; a reflective brightness enhancement film 45; a display panel 100; a black matrix layer 211; a pixel unit 212; a first electrode layer 221; a hole transport layer 222; a photosensitive layer 223; an electron transport layer 224; a second electrode layer 225; a second thin film transistor array substrate 226; an adhesive layer 241; a filled layer 242; a first black matrix line 2111; a second black matrix line 2112; a red subpixel 2121; a green subpixel 2122; a blue subpixel 2123; a convex lens unit 2410.

### DETAILED DESCRIPTION OF PREFERRED EMBODIMENTS

In the description of the present disclosure, it should be understood that terms such as “center,” “longitudinal,” “lateral,” “length,” “width,” “thickness,” “upper,” “lower,” “front,” “rear,” “left,” “right,” “vertical,” “horizontal,” “top,” “bottom,” “inside,” “outside,” “clockwise,” “counter-clockwise” as well as derivative thereof should be construed to refer to the orientation as then described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two, unless otherwise specified.

The disclosure herein provides many different embodiments or examples for realizing different structures of the present disclosure. In order to simplify the disclosure of the present disclosure, components and settings of specific examples are described below. Of course, they are only examples and are not intended to limit the present disclosure. Furthermore, reference numbers and/or letters may be repeated in different examples of the present disclosure. Such repetitions are for simplification and clearness, which per se do not indicate the relations of the discussed embodiments and/or settings. Moreover, the present disclosure provides examples of various specific processes and materials, but the applicability of other processes and/or application of other materials may be appreciated by a person skilled in the art.

In the description of the present disclosure, it should be noted that unless there are express rules and limitations, the terms such as “mount,” “connect,” and “bond” should be comprehended in broad sense. For example, it can mean a permanent connection, a detachable connection, or an integrated connection; it can mean a mechanical connection, an electrical connection, or can communicate with each other; it can mean a direct connection, an indirect connection by an intermediate, or an inner communication or an interaction between two elements. A person skilled in the art should understand the specific meanings in the present disclosure according to specific situations.

The present invention provides a display panel including a first substrate, a second substrate disposed opposite to the first substrate, and a liquid crystal layer disposed between the first substrate and the second substrate. The second substrate includes a pixel layer including a plurality of pixel units, and at least one fingerprint identification unit is disposed in the second substrate and located in a gap between the pixel units.

Preferably, the pixel layer includes a black matrix layer and the pixel units disposed in a plurality of grids of the black matrix layer and through the black matrix layer. The fingerprint identification units are disposed on a side of the black matrix layer.

Preferably, each of the pixel units includes three subpixels disposed abreast side by side. A length of the fingerprint identification unit is an integer multiple of a width of the three subpixels disposed abreast.

Preferably, the fingerprint identification unit includes: a first electrode layer disposed on the black matrix layer; a hole transport layer disposed on the first electrode layer; a photosensitive layer disposed on the hole transport layer; an electron transport layer disposed on the photosensitive layer; a second electrode layer disposed on the electron transport layer; and a second thin film transistor array substrate disposed on the second electrode layer and connected to a color filter substrate.

Preferably, the second substrate further includes: a color filter substrate disposed on the fingerprint identification units; and a light converging layer disposed on a side of the color filter substrate away from the fingerprint identification units. The light converging layer includes an adhesive layer. At least a convex lens unit is disposed on the adhesive layer, and the convex lens units and the fingerprint identification units are corresponding one by one in arrangement.

Preferably, the light converging layer further includes a filled layer, the filled layer is disposed on a side of the adhesive layer away from the color filter substrate.

Preferably, the second substrate further includes: a polarizer disposed on a side of the light converging layer away from the color filter substrate; an optically clear adhesive layer disposed on the polarizer; and a protective layer disposed on the optically clear adhesive layer.

Preferably, the first substrate includes a first thin film transistor array substrate and an alignment film disposed on the first thin film transistor array substrate and connected to the liquid crystal layer.

Preferably, the display panel further includes a planar light source disposed on a side of the first substrate away from the liquid crystal layer. The planar light source includes a reflective sheet, a light emitting diode disposed on the reflective sheet, a diffuser disposed on the light emitting diode, a brightness enhancement film disposed on the diffuser, and a reflective brightness enhancement film disposed on the brightness enhancement film and connected to the first substrate.

More detailed description of the embodiments are as follows:

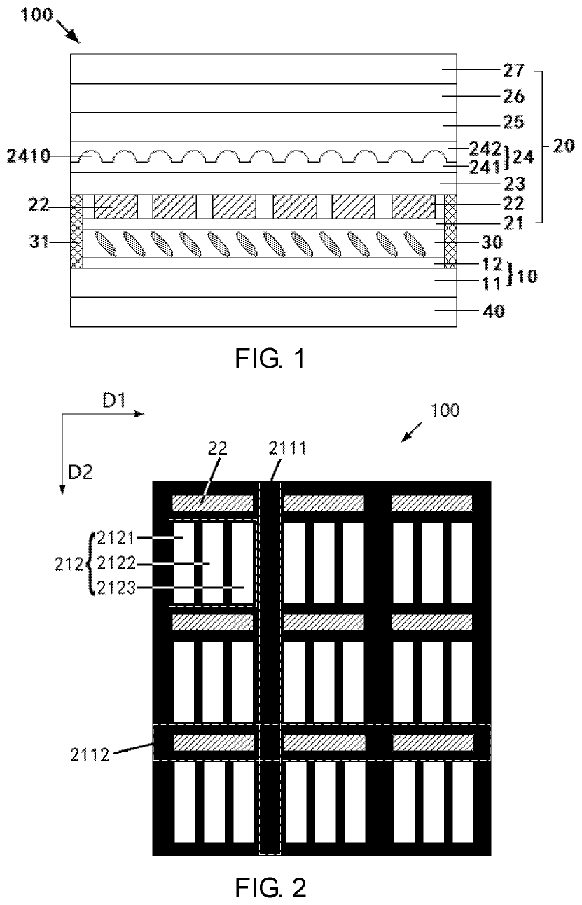

As shown in FIG. 1, one embodiment of the present invention provides a display panel 100 including a first substrate 10, a second substrate 20, and a liquid crystal layer 30 disposed between the first substrate 10 and the second substrate 20. Specifically, the second substrate 20 is disposed opposite to the first substrate 10. The liquid crystal layer 30 is disposed between the first substrate 10 and the second substrate 20.

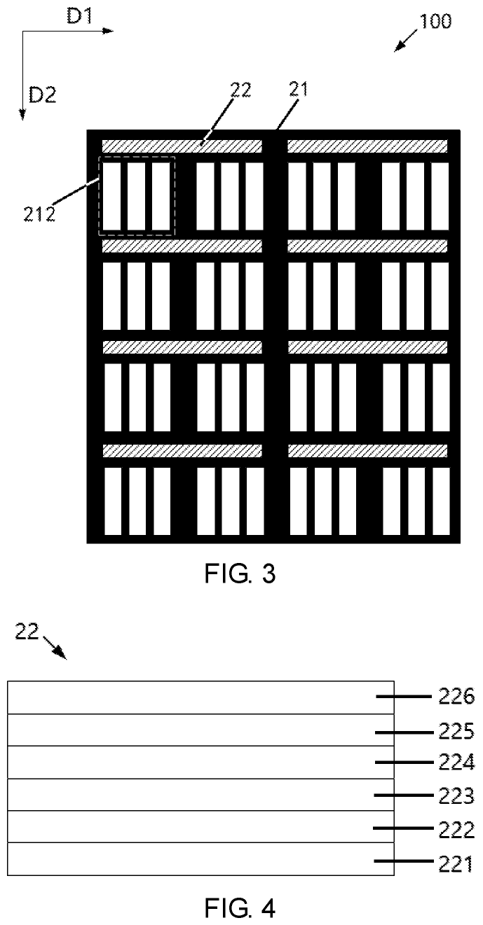

As shown in FIG. 1, a sealant layer 31 is disposed between the first substrate 10 and the second substrate 20 and is disposed surrounding the liquid crystal layer 30. The sealant layer 31 is used for connecting the first substrate 10 and the second substrate 20 and is used for packaging the liquid crystal layer 30 to form a liquid crystal box. The second substrate 20 includes a pixel layer 21 including a plurality of pixel units 212. The pixel layer 21 includes a black matrix layer 211 and the pixel units 212 disposed in a plurality of grids of the black matrix layer 211 and through the black matrix layer 211. Each of the pixel units 212 includes three subpixels which are a red subpixel 2121, a green subpixel 2122, and a blue subpixel 2123. The three subpixels are disposed abreast side by side to form the pixel units 212, specifically, as shown in FIG. 2 and FIG. 3.

The first substrate 10 includes a first thin film transistor array substrate 11 and an alignment film 12. The alignment film 12 is disposed on the first thin film transistor array substrate 11 and is connected to the liquid crystal layer 30. A drive voltage is applied to the alignment film 12 to align the liquid crystal layer 30, thereby controlling the liquid crystal box.

The second substrate 20 includes the black matrix layer 211, at least one fingerprint identification unit 22, and the color filter substrate 23 stacked sequentially. Specifically, the black matrix layer 211 is disposed on the liquid crystal layer 30, the fingerprint identification units 22 are disposed on a side of the black matrix layer 211, and the color filter substrate 23 is disposed on the fingerprint identification units 22. Each of the fingerprint identification units 22 includes an optical fingerprint identification sensor.

As shown in FIG. 2, FIG. 2 is a schematic plan structure of a display panel 100. A plurality of the pixel units 212 are disposed on the display panel 100, and the pixel units 212 are arranged in an array. The black matrix layers 211 are distributed at the interval between the pixel units 212. Specifically, the black matrix layers 211 are disposed at the interval between the pixel units 212 along a first direction D1 and a second direction D2. The first direction D1 and the second direction D2 are staggered. The first direction D1 is the disposing-abreast direction of the subpixels 221 of the pixel unit 212. The second direction D2 is the extending direction of the subpixels 221 of the pixel unit 212. In other words, the first direction D1 is perpendicular to the extending direction of the subpixels 221 of the pixel unit 212, and the second direction D2 is parallel to the extending direction of the subpixels 221 of the pixel unit 212. The black matrix layers 211 along the first direction D1 and the black matrix layers 211 along the second direction D2 form the black matrix layer 211. A width of the black matrix layer 211 along the first direction D1 is greater than a width of the black matrix layer 211 along the second direction D2. Preferably, in the present embodiment, the fingerprint identification units 22 are disposed on the black matrix layers 211, which are shown in FIG. 1, along the first direction D1.

In the present embodiment, the width of a first black matrix line 2111 along the first direction D1 is greater than the width of a second black matrix line 2112 along the second direction D2. Preferably, in the present embodiment, the fingerprint identification units 22 are disposed on the black matrix layers 2112, which are shown in FIG. 1, along the first direction D1.

In another embodiment, the fingerprint identification units 22 can be disposed on a first black matrix line 2111 along the first direction D1 and a second black matrix line 2112 along the second direction D2, which increases the number of arranged fingerprint identification units 22, thereby increasing the sensitivity of fingerprint identification.

As shown in FIG. 2 and FIG. 3, in the present embodiment, the fingerprint identification units 22 are arranged in an equally spaced manner. A length of the fingerprint identification unit 22 is an integer multiple of the width of the three subpixels 2121, 2122, 2123 disposed abreast of the pixel unit 212. The value of the integer multiple can be 1, 2, 3, or all other integers. As shown in FIG. 2, the length of the fingerprint identification units 22 are preferably equal to the width of the three subpixels 2121, 2122, 2123 disposed abreast of the pixel unit 212. As shown in FIG. 3, the length of the fingerprint identification units 22 can also be preferably two times greater than the width of the three subpixels 2121, 2122, 2123 disposed abreast of the pixel unit 212. The length of the fingerprint identification units 22 can be modified according to the practical demand. If the fingerprint identification units 22 only need a fingerprint identification function, the fingerprint identification units 22 can even be linked to form grids.

As shown in FIG. 4, each of the fingerprint identification units 22 includes a first electrode layer 221, a hole transport layer 222, a photosensitive layer 223, an electron transport layer 224, a second electrode layer 225, and a second thin film transistor array substrate 226 stacked sequentially. Specifically, the first electrode layer 221 is disposed on the black matrix layer 211, the hole transport layer 222 is disposed on the first electrode layer 221, the photosensitive layer 223 is disposed on the hole transport layer 222; the electron transport layer 224 is disposed on the photosensitive layer 223, the second electrode layer 225 is disposed on the electron transport layer 224, and the second thin film transistor array substrate 226 is disposed on the second electrode layer 225 and is connected to a color filter substrate 23.

As shown in FIG. 1, in the present embodiment, the second substrate 20 further includes a light converging layer 24 disposed on a side of the color filter substrate 23 away from the fingerprint identification units 22. The light converging layer 24 includes an adhesive layer 241. At least one convex lens unit 2410 is disposed on the adhesive layer 241, and the convex lens unit 2410 and the fingerprint identification units 22 are disposed corresponding to each other. The convex portions of the convex lens units 2410 are disposed away from the fingerprint identification units 22. The light converging layer 24 with convex lens function is prepared by nanoimprint and is disposed on a side of the color filter substrate 23 away from the fingerprint identification units 22. Material of the light converging layer 24 includes an ultraviolet (UV) adhesive.

As shown in FIG. 1, in the present embodiment, the light converging layer 24 further includes a filled layer 242 disposed on a side of the adhesive layer 241 away from the color filter substrate 23. The material of the filled layer 242 can be ink or other low-refractive-index materials, thereby making the convex lens units 2410 effectively perform the converging effect.

As shown in FIG. 1, in the present embodiment, the second substrate 20 further includes a polarizer 25, an optically clear adhesive layer 26, and a protective layer 27. Specifically, the polarizer 25 is disposed on a side of the light converging layer 24 away from the color filter substrate 23, the optically clear adhesive layer 26 is disposed on the polarizer 25, and the protective layer 27 is disposed on the optically clear adhesive layer 26.

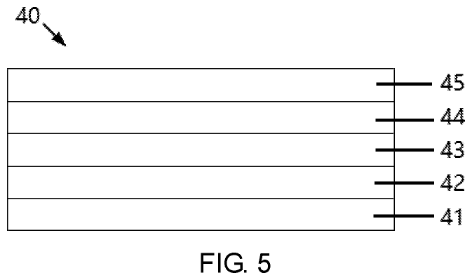

As shown in FIG. 1 and FIG. 5, in the present embodiment, the display panel 100 further includes a planar light source 40 disposed on a side of the first substrate 10 away from the liquid crystal layer 30. The planar light source 40 includes a reflective sheet 41, a light emitting diode 42, a diffuser 43, a brightness enhancement film 44, and a reflective brightness enhancement film 45 stacked sequentially. Specifically, the light emitting diode 42 is disposed on the reflective sheet 41, the diffuser 43 is disposed on the light emitting diode 42, the brightness enhancement film 44 is disposed on the diffuser 43, and the reflective brightness enhancement film 45 is disposed on the brightness enhancement film 44 and is connected to the first substrate 10.

In other embodiments, A structure of the planar light source 40 can be other kinds of structures, as long as the structures can increase uniformity of light and reflect light source, it should fall within the protection scope of the present invention.

When a finger touches the working display panel 100, the light emitted from the planar light source 40 passes through all layers of the display device and arrives in the finger. Because intensities of reflected lights from finger valleys and finger ridges are different, the light intensities received by the fingerprint identification units 22 are different, and the electrical signals converted from the reflected lights are different, thereby realizing fingerprint identification. Furthermore, light distributed in a larger angle range is incident to the fingerprint identification units 22 in a smaller angle range, which avoids the light from being interfered and reduces the interference between the adjacent pixel units.

The present invention further provides a display device including the above display panel 100.

The display device according to the present invention integrates the fingerprint identification function, namely, the fingerprint identification units are formed on a color filter substrate of the display panel. Specifically, the display function, the touch control function, and the fingerprint identification function are integrated on the color filter substrate of the display panel, thereby reducing cost and thickness of a module. Furthermore, by disposing a light converging layer, light distributed in a larger angle range is incident to the fingerprint identification units in a smaller angle range, which avoids the light from being interfered and reduces the interference between the adjacent pixel units. Further, a planar light source is applied to the display panel to increase uniformity of backlight, which solves the problem about nonuniformity of backlight of fingerprint identification units, thereby improving image quality of the fingerprint identification units. As a result, uniformity of grayscale of the whole fingerprint image is improved, utilization of a light source is increased, and energy consumption is decreased.

The display device according to the above embodiments can be a mobile phone, a tablet, a television, a display device, a laptop, a digital photo frame, a navigation device, or other products or components with the display function.

The advantageous effects of the present invention: a display panel and a display device are provided. Fingerprint identification units are formed on a color filter substrate of the display panel to integrate functions of display, touch control, and fingerprint identification, thereby reducing cost and thickness of a module. Furthermore, by disposing a light converging layer, light distributed in a larger angle range is incident to the fingerprint identification units in a smaller angle range, which avoids the light from being interfered and reduces the interference between the adjacent pixel units. Further, a planar light source is applied to the display panel to increase uniformity of backlight, which solves the problem about nonuniformity of backlight of fingerprint identification units, thereby improving image quality of the fingerprint identification units. As a result, uniformity of grayscale of the whole fingerprint image is improved, utilization of a light source is increased, and energy consumption is decreased.

The above are only preferred embodiments of the present invention, it should be noted that those of ordinary skill in the art, in the art without departing from the principles of the present invention is provided, can make various modifications and variations, these improvements and modifications should also be regarded as the protection scope of the present invention.

What is claimed is:

1. A display panel, comprising:
a first substrate;
a second substrate disposed opposite to the first substrate; and
a liquid crystal layer disposed between the first substrate and the second substrate;
wherein the second substrate comprises a pixel layer comprising a plurality of pixel units, and at least one fingerprint identification unit is disposed in the second substrate and located in a gap between the pixel units.

2. The display panel as claimed in claim 1, wherein the pixel layer comprises a black matrix layer and the pixel units disposed in a plurality of grids of the black matrix layer and through the black matrix layer; the fingerprint identification units are disposed on a side of the black matrix layer.

3. The display panel as claimed in claim 1, wherein each of the pixel units comprises three subpixels disposed abreast side by side; a length of the fingerprint identification unit is an integer multiple of a width of the three subpixels disposed abreast.

4. The display panel as claimed in claim 2, wherein the fingerprint identification unit comprises:
a first electrode layer disposed on the black matrix layer;
a hole transport layer disposed on the first electrode layer;
a photosensitive layer disposed on the hole transport layer;
an electron transport layer disposed on the photosensitive layer;
a second electrode layer disposed on the electron transport layer; and
a second thin film transistor array substrate disposed on the second electrode layer.

5. The display panel as claimed in claim 1, wherein the second substrate further comprises:
a color filter substrate disposed on a side of the fingerprint identification units; and
a light converging layer disposed on a side of the color filter substrate away from the fingerprint identification units;
wherein the light converging layer comprises an adhesive layer, at least a convex lens unit is disposed on the adhesive layer, the convex lens units and the fingerprint identification units are corresponding one by one in arrangement.

6. The display panel as claimed in claim 5, wherein the light converging layer further comprises a filled layer, the filled layer is disposed on a side of the adhesive layer away from the color filter substrate.

7. The display panel as claimed in claim 5, wherein the second substrate further comprises a polarizer disposed on a side of the light converging layer away from the color filter substrate;
an optically clear adhesive layer disposed on the polarizer; and
a protective layer disposed on the optically clear adhesive layer.

8. The display panel as claimed in claim 1, wherein the first substrate comprises a first thin film transistor array substrate;
an alignment film disposed on the first thin film transistor array substrate, wherein the alignment film is connected to the liquid crystal layer.

9. The display panel as claimed in claim 1 further comprises:
a planar light source disposed on a side of the first substrate away from the liquid crystal layer;
wherein the planar light source comprises
a reflective sheet;
a light emitting diode disposed on the reflective sheet;
a diffuser disposed on the light emitting diode;
a brightness enhancement film disposed on the diffuser; and
a reflective brightness enhancement film disposed on the brightness enhancement film; wherein the reflective brightness enhancement film is connected to the first substrate.

10. A display device comprises the display panel as claimed in claim 1.
